(19) United States
(12) Patent Application Publication
(10) Pub. No.: US 2016/0142344 A1
(43) Pub. Date: May 19, 2016

(54) AUTOMATED RESPONSE ACTION IN MESSAGING APPLICATION

(71) Applicant: Citrix Systems, Inc., Fort Lauderdale, FL (US)

(72) Inventors: Ankit Mandhani, San Francisco, CA (US); Ashish V. Thapliyal, Santa Barbara, CA (US); Anne Marie Lock, Brooklyn, NY (US); Elizabeth Thapliyal, Santa Barbara, CA (US); Ryan W. Kasper, Santa Barbara, CA (US)

(21) Appl. No.: 14/543,246

(22) Filed: Nov. 17, 2014

(51) Int. Cl. H04L 12/58; G06F 17/30

(52) U.S. Cl. CPC H04L 51/02; G06F 17/30654

(57) ABSTRACT

A messaging application such as an email application receives an electronic message including request text, and automatically analyzes the electronic message to extract the request text and match it to a matching predefined request. Predefined requests are associated with respective functions of the messaging application generating electronic messaging items. The electronic messaging item associated with the matching request is automatically generated. As an example, a matching request may be a request for a reply containing requested information. The requested information is obtained, and a reply message is automatically generated using a compose or reply function of the messaging application. The reply message can be presented to a user to enable the user to modify the message before it is sent.

### BACKGROUND

The disclosure is related to the field of electronic mail (email) or similar messaging systems.

### SUMMARY

Users of email systems may spend time composing replies to messages containing simple questions or requests, such as a request for availability for a meeting for example. User efficiency might be enhanced if the user is freed from the need to respond or take other straightforward action based on requests of well-known types contained in received messages.

Methods and apparatus are disclosed for automating certain activities in a messaging application such as an email application. A disclosed method includes receiving an electronic message including request text, and automatically analyzing the electronic message to extract the request text and match the extracted request text to a matching one of a set of predefined requests. The requests are associated with respective functions of the messaging application and corresponding electronic messaging items. The method further includes automatically generating the electronic messaging item associated with the matching request.

As an example, the matching request may be a request for a reply with requested information. The requested information is obtained, and a reply message is automatically generated using a compose or reply function of the messaging application. The reply message might be presented to the user, enabling the user to augment or otherwise modify the reply message before it is sent.

Through use of the disclosed method, users can save time by having replies to simple questions automatically drafted by the messaging application rather than being generated by the user. Other uses of the disclosed method include automatic generation of task items, calendar items, and other items of the messaging application.

### BRIEF DESCRIPTION OF THE DRAWINGS

The foregoing and other objects, features and advantages will be apparent from the following description of particular embodiments of the invention, as illustrated in the accompanying drawings in which like reference characters refer to the same parts throughout the different views.

FIG. 1 is a block diagram of a computerized device such as a personal computer or smartphone;

FIG. 2 is a block diagram of software-implemented functional components of a computerized device;

FIG. 3 is a flow diagram of operation of a computerized device.

### DETAILED DESCRIPTION

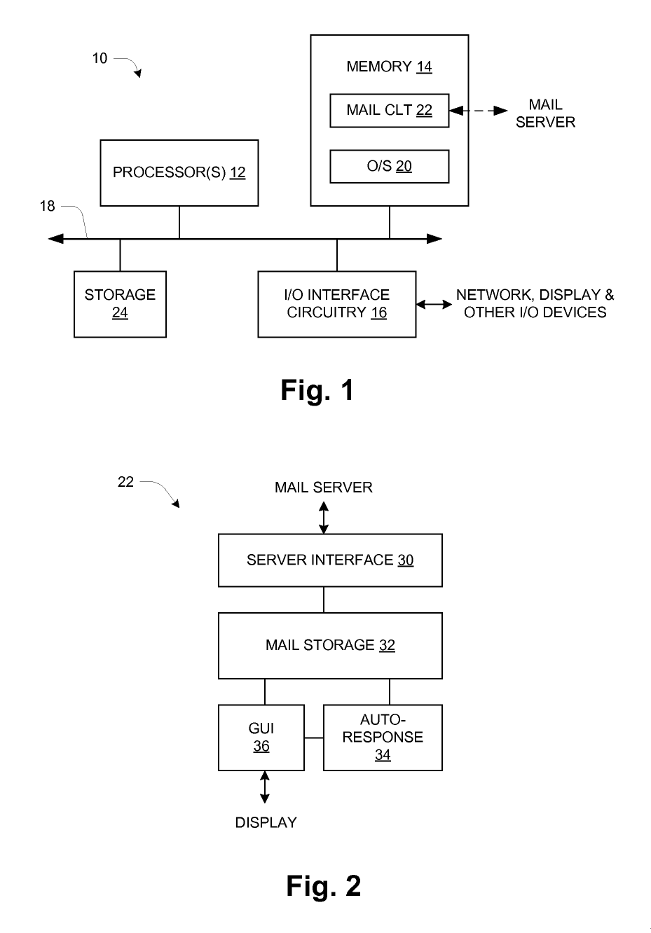

FIG. 1 shows a configuration of computerized device 10. The hardware includes one or more processors 12, memory 14, and interface circuitry 16 interconnected by data interconnections 18 such as one or more high-speed data buses. The interface circuitry 16 provides a hardware connection to an external network, a user interface display, and other input/output (I/O) devices. As shown, the memory 14 stores an operating system (O/S) 20 and an application program referred to as a “mail client” (MAIL CLT) 22 that interacts with a separate mail server. The processor(s) 12 with connected memory 14 may also be referred to as “processing circuitry” herein. There may also be local storage 24 such as a local-attached disk drive or Flash drive. In operation, the processor(s) 12 execute computer program instructions of the O/S 20 and mail client 22 to cause the hardware to function in a software-defined manner. Thus the computer hardware executing instructions of the mail client application 22, for example, can be referred to as a mail client circuit or mail client component, and it will be understood that a collection of such circuits or components can all be realized and interact with each other as one or more sets of computer processing hardware executing different computer programs as generally known in the art. Further, the application software may be stored on a non-transitory computer-readable medium such as an optical or magnetic disk, Flash memory or other non-volatile semiconductor memory, etc., from which it is retrieved for execution by the processing circuitry, as also generally known in the art.

The computerized device 10 of FIG. 1 may be realized in any of a number of commercial forms, including for example a conventional desktop computer, a portable computer, and a smaller portable device such as a smartphone. In conventional desktop and portable computer environments, the mail client 22 may be a so-called “fat” application, i.e., one that is installed on the user device, contains all the required data and program elements (e.g., as libraries), and is executed completely locally on a user device. However, it will be appreciated that the disclosed techniques may also be realized by other forms of implementation. In particular, the techniques may also be used in so-called thin-client or Web access environments in which many functions are performed by memory-resident applets in the context of a browser application executed on a user device, with separate server code being executed at a separate webmail server.

FIG. 2 shows the organization of the mail client 22. Major components include a server interface 30, mail storage 32, an auto-response module 34 and a graphical user interface (GUI) 36. As generally known in the art, the mail client 22 communicates with the remote mail server using a mail delivery protocol such as Post Office Protocol (POP), Internet Message Access Protocol (IMAP), etc. to send and receive emails. Received emails, and generally sent emails as well, are stored in the mail storage 32, which may be realized for example as a large, locally stored mail file such as known in the art. Both the auto-response module 34 and GUI 36 operate upon emails that are stored in the mail storage 32. The GUI 36 provides conventional functions such as viewing contents of the mail storage 32 (e.g. using a folder type of paradigm as generally known), reading emails, and composing and sending new emails. As described more particularly below, the auto-response module 34 automatically analyzes received emails and initiates responsive actions to improve efficiency and effectiveness of the email user.

As noted above, an email user may need to spend time composing replies to simple questions, or more generally to spend time and attention responding to questions or requests contained in received emails. Examples include things like requests for personal information (What is your address?), availability for meetings, etc. The burden of responding to such emails is reduced by use of the auto-response module 34 which automatically detects the presence of questions or requests in received emails and initiates appropriate responsive action when possible, such as auto-drafting a reply message containing requested information. This can save the user at least part of the task, and can be especially useful on smaller devices such as mobile phones where user input may be cumbersome.

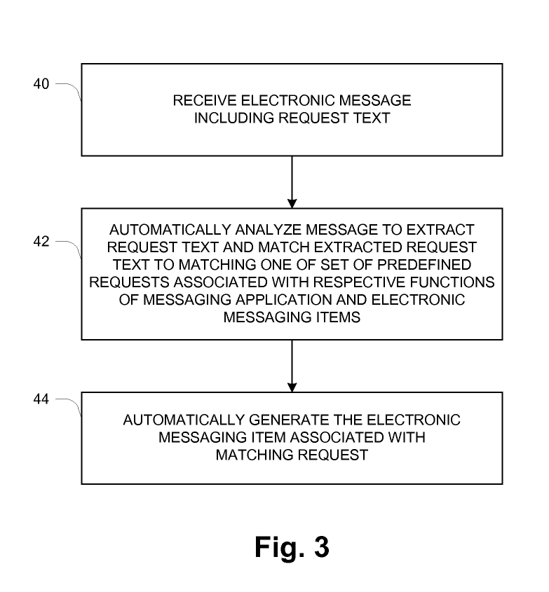

FIG. 3 shows general operation of the mail client 22 including the auto-response module 34 in relevant part. At 40, the mail client 22 receives an electronic message (i.e., email) that includes request text. The mail client 22 stores the received message in the mail storage 32. The request text contains a question or request that is to be answered or satisfied by the receiving user. Example questions and requests include the following: “What is your address?”; “What is your phone number?”; “Are you available tomorrow?”; “When are you available this week?”; etc. Because the request text is typically unstructured text generated by a human as the message sender, a given type of request may be expressed in a variety of ways. For example, the following are different ways that a person's availability for a meeting can be requested:

Please let me know your availability next week.

Are you available next week?

Please send your availability for the week of the 20^{th}.

When are you free for a meeting next week?

At 42, the auto-response module 34 automatically analyzes the received message to extract the request text and match the extracted request text to a matching one of a set of predefined requests, where the predefined requests are associated with functions of the messaging application generating corresponding electronic messaging items. The analyzing may include normalizing the request text and matching it against a set of pre-defined text questions and requests. Normalizing is explained below. The pre-defined text questions and requests might be assumed or learned phrases or sentences that express a given question or request. There may be one or more predefined phrases/sentences for a given type of request. For example, the auto-response module 34 may store the following two specific examples of requests for availability:

Provide availability

When are you available

Once a question or request has been identified, at 44 an electronic messaging item associated with the matching request is automatically generated. In many cases, the electronic messaging item will be a newly composed message to be sent as a reply to the received message that has been processed, containing an answer and/or information in response to the question or request. An answer can be generated by automatically looking up the user's information, such as name, address, phone number, free time on calendar, etc. Further, the system could either ask the user for the relevant information, find the information in the user's calendar, contacts, or other location, or it can just learn the response based on previous replies sent by the user for the same question.

For several questions, the processing at 44 may be as simple as looking up the user information such as address/phone number etc. Questions like “Are you available tomorrow?” and “When are you available this week?” are a bit more complicated. First the auto-response module 34 determines what time period the question is about by looking for keywords such as “today”, “tomorrow”, “next week”, etc. Next it looks up the user's calendar to determine when the user is free. Finally it composes an answer that includes the free times on the calendar.

As mentioned, the request text in the message are normalized and then matched. This may be done using standard Natural Language Processing techniques such as stemming, root word determination, and semantic equivalence rules for the likely words in the questions. Because there is a limited class of simple questions, this type of processing can be done efficiently and with good enough accuracy to be useful.

Although the above description provides the example of a reply message as being automatically generated, other types of electronic messaging items may be generated. A messaging application may include functions and items for calendars, contacts, tasks, notes, and other aspects of user activity. Thus the electronic messaging item that is automatically generated may be a task item describing a task to be performed by the user based on the request text. Analogous operations can be performed in some or all of the other areas.

Another aspect of the messaging application might be monitoring operation and using information obtained during the monitoring to generate responsive messaging items and/or provide requested information. For example, the auto-response module 34 might monitor a pattern of user response to certain messages and then begin auto-generating similar responses. More specifically, the application can store response data obtained from reply messages sent in response to corresponding request messages, and then obtain requested information from the stored response data when generating a responsive reply message.

While various embodiments of the invention have been particularly shown and described, it will be understood by those skilled in the art that various changes in form and details may be made therein without departing from the spirit and scope of the invention as defined by the appended claims.

What is claimed is:

1. A method of operating a computer executing a messaging application, comprising:
receiving an electronic message including request text;
automatically analyzing the electronic message to extract the request text and match the extracted request text to a matching one of a set of predefined requests, the requests being associated with respective functions of the messaging application generating corresponding electronic messaging items; and
automatically generating the electronic messaging item associated with the matching request.

2. A method according to claim 1, wherein the matching request is a request for a reply message with requested information, and wherein automatically generating the electronic messaging item includes automatically generating the reply message.

3. A method according to claim 2, wherein the matching request is a question and the requested information is an answer to the question.

4. A method according to claim 3, wherein the requested information is obtained from information for a user of the messaging application stored in the computer.

5. A method according to claim 3, wherein the requested information is obtained by (i) matching keywords of the request text to keywords of the matching request, and (ii) retrieving the answer to the question based on the matching keywords.

6. A method according to claim 3, further including, as part of generating the reply message, querying a user of the messaging application for the answer to the question.

7. A method according to claim 2, further including:
monitoring operation of the messaging application and storing response data obtained from reply messages sent in response to corresponding request messages; and
obtaining the requested information from the stored response data.

8. A method according to claim 1, wherein automatically analyzing the electronic message includes normalizing the request text.

9. A method according to claim 8, wherein normalizing the request text including natural language processing including stemming, determining root words, and applying semantic equivalence rules.

10. A method according to claim 1, wherein the electronic messaging item is a task item describing a task to be performed by the user based on the request text.

11. A non-transitory computer-readable medium storing computer program instructions of a messaging application, the instructions being executable by a set of one or more computers to cause the computers to perform a method including:
receiving an electronic message including request text;
automatically analyzing the electronic message to extract the request text and match the extracted request text to a matching one of a set of predefined requests, the requests being associated with respective functions of the messaging application generating corresponding electronic messaging items; and
automatically generating the electronic messaging item associated with the matching request.

12. A non-transitory computer-readable medium according to claim 11, wherein the matching request is a request for a reply message with requested information, and wherein automatically generating the electronic messaging item includes automatically generating the reply message.

13. A non-transitory computer-readable medium according to claim 12, wherein the matching request is a question and the requested information is an answer to the question.

14. A non-transitory computer-readable medium according to claim 13, wherein the requested information is obtained from information for a user of the messaging application stored in the computer.

15. A non-transitory computer-readable medium according to claim 13, wherein the requested information is obtained by (i) matching keywords of the request text to keywords of the matching request, and (ii) retrieving the answer to the question based on the matching keywords.

16. A non-transitory computer-readable medium according to claim 13, wherein the method further includes, as part of generating the reply message, querying a user of the messaging application for the answer to the question.

17. A non-transitory computer-readable medium method according to claim 12, wherein the method further includes:
monitoring operation of the messaging application and storing response data obtained from reply messages sent in response to corresponding request messages; and
obtaining the requested information from the stored response data.

18. A non-transitory computer-readable medium according to claim 11, wherein automatically analyzing the electronic message includes normalizing the request text.

19. A non-transitory computer-readable medium according to claim 18, wherein normalizing the request text including natural language processing including stemming, determining root words, and applying semantic equivalence rules.

20. A non-transitory computer-readable medium according to claim 11, wherein the electronic messaging item is a task item describing a task to be performed by the user based on the request text.
